(19) United States
(12) Patent Application Publication
(10) Pub. No.: US 2026/0341574 A1
(43) Pub. Date: Oct. 29, 2026

(54) FOUR LEG COUPLED INDUCTOR

(71) Applicant: GE Aviation Systems LLC, GRAND RAPIDS, MI (US)

(72) Inventors: Xiaosong Kang, Beavercreek, OH (US); Jason Randall Gulley, Liberty Township, OH (US); Jonathan Phillip Zeto, Springboro, OH (US)

(21) Appl. No.: 19/188,187

(22) Filed: Apr. 24, 2025

(51) Int. Cl. H01F 27/24; H01F 3/14; H01F 27/22; H01F 41/02

(52) U.S. Cl. CPC H01F 27/24; H01F 3/14; H01F 27/22; H01F 41/0206

(57) ABSTRACT

A coupled inductor includes a four-leg magnetic core with C-shaped segments cooperatively defining three windows. A respective coil or phase winding is wound around each leg, and a portion of two respective phase windings is disposed in each respective window. The magnetic core can be laminated-type construction formed with nanocrystalline material. Two air gaps can be defined through each leg. The magnetic core can be supported by a baseplate having heat conducting fins.

### TECHNICAL FIELD

This disclosure relates to an inductive device and more specifically to a four-leg coupled inductor.

### BACKGROUND

Conventional single-phase and multi-phase alternating current (AC) power supply circuits typically include an electrical low-pass filter to block high-frequency AC ripple current or “noise” from an AC output signal, while allowing low-frequency AC current to pass. The high-frequency AC ripple current is typically generated as a consequence of a pulse width modulation (PWM) switching operation of semiconductor devices. The high-frequency AC ripple current can include harmonic noise that, if unfiltered, will cause distortion of the AC output signal. Low-pass filters circuit typically include one or more inductors to provide a high-impedance to high-frequency noise and low impedance to low-frequency AC current. The inductor typically includes a ferromagnetic core having an electrically conductive winding coiled around it.

### BRIEF DESCRIPTION OF THE DRAWINGS

A full and enabling disclosure of the present description, including the best mode thereof, directed to one of ordinary skill in the art, is set forth in the specification, which refers to the appended FIGS., in which:

FIG. 1 is a perspective view of a coupled inductor in accordance with various aspects described herein.

FIG. 2A is an isometric front view of a magnetic core of the coupled inductor of FIG. 2 in accordance with various aspects described herein.

FIG. 2B is an isometric top view of the magnetic core of the coupled inductor of FIG. 2 in accordance with various aspects described herein.

FIG. 3 is a perspective view of a winding of the coupled inductor of FIG. 2 in accordance with various aspects described herein.

FIG. 4 is a perspective view of a baseplate of the coupled inductor of FIG. 2 in accordance with various aspects described herein.

FIG. 5 is a flow diagram of a method of forming a four-leg coupled inductor, according to another aspect of the present disclosure.

### DETAILED DESCRIPTION

Aspects of the present disclosure are directed to a coupled inductor. For purposes of illustration, the present disclosure will be described with respect to a four-leg coupled inductor such as used in a power distribution system (e.g., of an aircraft) as a differential mode filter. The disclosure can have applicability in a variety of electrical inductive devices and power distribution systems, and can be used to provide benefits in other industrial, commercial, military, and residential applications. Further non-limiting examples of other vehicles or engines to which the disclosure can relate can include boats, helicopters, cars, or other aquatic, air, space, or land vehicles. Industrial, commercial, or residential applications of the disclosure can include, but are not limited to, marine power plants, wind turbines, hybrid-electric machines, or small power plants. It will be understood, however, that the present disclosure is not so limited and can have general applicability in non-aircraft applications, such as power distribution requirements in non-aircraft power distribution applications.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all aspects described herein should be considered exemplary.

As used herein, the terms “first,” “second,” and “third” and the like, can be used interchangeably to distinguish one component from another and are not intended to signify location or importance of the individual components. The singular forms “a”, “an”, and “the” include plural references unless the context clearly dictates otherwise. Furthermore, as used herein, the term “set” or a “set” of elements can be any number of elements, including only one. All directional references (e.g., inner, outer, upper, lower, radial, axial, proximal, distal, upper, lower, upward, downward, left, right, lateral, front, back, top, bottom, above, below, vertical, horizontal, clockwise, counterclockwise, upstream, downstream, aft, etc.) are only used for identification purposes to aid the reader’s understanding of the present disclosure, and do not create limitations, particularly as to the position, orientation, or use of the present disclosure.

Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other.

As used herein, elements being “electrically connected,” “electrically coupled,” include an electric transmission or signal being sent, received, or communicated to or from such connected or coupled elements. Furthermore, such electrical connections or couplings can include a wired or wireless connection, or a combination thereof. In non-limiting examples, connections or disconnections can be selectively configured to provide, enable, disable, or the like, an electrical connection between respective elements. Additionally, while terms such as “voltage”, “current”, and “power” can be used herein, it will be evident to one skilled in the art that these terms can be interrelated when describing aspects of the electrical circuit, or circuit operations.

As used herein, the term “electrically insulative”, “insulator”, or “insulation” refers to a material that exhibits a low electrical conductivity (for example, less than about 10-8 siemens per meter (S/m)). Unless stated otherwise, as used herein, the term “insulative” refers to electrical insulation, and the term “insulator” refers to an electrical insulator.

As used herein, the term “conductivity” refers to a property of a material that allows a flow of charge or electric current therethrough. Also as used herein, the term “electrical conductor” refers to a material that exhibits a relatively high electrical conductivity (for example, greater than about 10-7 S/m). Unless stated otherwise, as used herein, the term “conductive” refers to electrical conductivity, and the term “conductor” refers to an electrical conductor.

As used herein, the terms “inductance” or “self-inductance” refers to a property of an electrically conductive coil that opposes changes to a current flowing through it. Also as used herein, the term “mutual inductance” of two magnetically coupled coils refers to a ratio of a time-varying magnetic flux created by one electrically conductive coil being induced into the other electrically conductive coil. Also, as used herein, the term “equivalent inductance” refers to a total inductance of multiple inductors connected in series or parallel, including their respective self-inductances, and any mutual inductance between them.

An inductor is a passive two-terminal electrical component typically used to add inductance to an electrical circuit. Inductance is the property of a conductor that resists changes in current flow, and is caused by a magnetic field generated around the conductor when current passes through it. When the current changes, this magnetic field induces a voltage (known as electromotive force or EMF) that opposes the change, as described by Lenz’s Law. Inductors typically include an insulated wire wound into a coil that stores energy in the generated magnetic field (e.g., measured as a magnetic flux passing through a surface). The inductance of the coil can be proportional to the number of turns or windings in the coil. The inductance can also depend on the shape of the coil, separation of the windings, and many other factors. Conventional inductors typically include a "magnetic core" made of a ferromagnetic material (e.g., iron) inside the coil. The magnetic field from the coil induces magnetization in the ferromagnetic material, which increases the magnetic flux. The efficiency of the inductor can decrease as the frequency of the current (e.g., an AC current frequency) increases, for example, due to eddy currents in the core material and skin effect on the windings.

Inductors can often be arranged as “coupled inductors” having two or more inductors wound on a common magnetic core. The inductors are magnetically coupled to each other when energized. Conventional coupled inductor cores are typically formed using a C- shaped magnetic core that is coupled at its distal ends with an I-shaped or another C-shaped magnetic core to define a rectangular closed magnetic core having two magnetic legs. Inductors or windings may be coiled or wound on one or both legs of the magnetic core to define the coupled inductor. In other conventional arrangements, at least one of the magnetic cores can have an E-shape to form a symmetric closed magnetic system having three magnetic legs. Typically, an inductor is wound around the center leg of the E-shaped magnetic core, whose section area is twice that of each individual outer leg. In other instances, (e.g., a three-phase coupled inductor core), the magnetic core legs can be of equal size, and the three legs can support a respective winding or inductor.

Coupled inductors are often used in power converters such as DC-DC converters, or DC-AC converters (e.g., a three-phase inverter), and the like, by transferring energy from one winding to the other through the common magnetic core.

A conventional three-phase inverter is a device that converts a DC input voltage into a three-phase AC output. This DC-AC conversion is typically accomplished using a power semiconductor switching topology. For example, a conventional three-phase Pulse Width Modulation (PWM) inverter uses a set of six semiconductor switching devices arranged in three "phase legs" (e.g., one leg per AC phase) to convert the DC input voltage into the three-phase AC output voltage with precise voltage and frequency control. Typically, each phase voltage is controlled by respective PWM signals that are provided to each respective semiconductor switching device. The PWM signals operatively control a respective "on-time" of each semiconductor switching device. For example, the duration and sequencing of the on-time of each semiconductor switching device can be controlled to arrange a 120-degree phase shift between each phase leg, resulting in a balanced three-phase AC voltage output.

Three-phase inverters are often used in conventional electrical power systems, for example to integrate renewable energy resources into the grid, such as solar photovoltaics (PVs) and wind turbines. When the three-phase inverters are used to feed unbalanced three-phase loads, three-phase four-wire inverters, (e.g., including a neutral line), are typically used to provide a current path for zero-sequence currents (e.g., neutral currents). There are various conventional topologies for three-phase four-wire inverters. For example, a conventional three-phase, three leg inverter with split DC bus capacitors (so called “split-link” topology) typically connects a neutral point of an AC load to the midpoint of a DC bus. However, since a neutral current flows through the DC bus capacitors, a relatively high capacitance is typically utilized for unbalanced load conditions (e.g., when a power demand across the three-phase load is uneven), adding extra cost and complexity. Another drawback is that in some cases, the neutral point can shift and become “non-neutral” in practice.

Another conventional topology is the three-phase, four-leg inverter which adds a fourth leg, called a neutral leg, to the three-leg inverter to accommodate neutral currents. The three-phase, four-leg inverter can provide improved control for unbalanced loads by providing a stable neutral point, and can improve utilization of the DC-bus voltage compared to the split-link topology (e.g., a 15% higher output). Typically, each phase leg and the neutral leg include a respective pair of semiconductor switching devices coupled together to define a half-bridge, and a respective inductor (e.g., a differential-mode inductor). The neutral leg inductor is electrically coupled between a mid-point of the respective half-bridge and an AC output neutral point. When the three-phase load is balanced, the neutral leg inductor will only conduct high-frequency AC ripple currents when the low frequency neutral AC current is close to zero. When the three-phase load is unbalanced, the neutral leg inductor will conduct both the high-frequency AC ripple current, and lower frequency AC current. The high-frequency AC ripple current will increase a magnetic core loss in the neutral leg inductor. To attenuate the high-frequency AC ripple current (e.g., to decrease the neutral inductor core loss) the inductance of the neutral inductor can be increased. For example, for a neutral inductor in a 50 kilowatt, 115VAC, 3-phase 4-leg inverter with 50 kilohertz PWM switching frequency, at least a 14 microhenry (uH) inductor can be used. Typically, the neutral inductor is selected based on a predetermined trade-off between physical size, maximum flux density (e.g., a strength of a magnetic field per unit area), high-frequency core loss (e.g., an energy loss due to hysteresis and eddy currents) and inductance. Achieving this balance can be particularly challenging when there is limited space available for the inductor (e.g., in an aircraft), and in relatively high ambient temperature applications (e.g., above 140 degrees Celsius).

For example, some conventional four-leg coupled inductors attempt to achieve a balance between physical size, maximum flux density, high-frequency core loss, and inductance by defining an air gap within the magnetic core (e.g., a gapped inductor) to control the inductance and prevent core saturation. However, since the reluctance of the air gap is greater than that of the magnetic core material, magnetic flux lines can spread out or “fringe” at the edges of the air gap, leading to increased eddy currents and core losses. Other conventional inductors, so called “gapless inductors” can omit the air gap, and use materials such as a metallic magnetic powder or specific ferrite compositions to achieve high permeability while reducing core losses and maintaining temperature stability. For example, some conventional gapless coupled inductors use a ferrite material to form the magnetic core and a relatively small number of winding turns to define the inductor. However, while ferrite materials can provide core loss advantages for inductors at high frequencies, the ferrite materials generally exhibit a low magnetic permeability, making it challenging to achieve a higher inductance values within limited physical size dimension. Moreover, in the gapless inductor, inductive coupling among phases is limited by a geometry of the core structure, which makes it difficult to arrange power terminals or leads during assembly.

It would be desirable to provide a differential mode inductive filter for three phase, four wire applications that is unitary, light weight, compact in size, can operate with reduced heat and reduced losses. Aspects as disclosed herein can provide a four-leg coupled inductor that overcomes the aforementioned problems, while enabling a balance between physical size, maximum flux density, high-frequency core loss, and inductance. Aspects as disclosed herein can include a four-leg gapped magnetic core having eight C-shaped core segments cooperatively arranged to form four legs, defining three windows. Aspects as disclosed herein can further provide a magnetic core having a relatively high inductive coupling among each of the four legs, with each leg’s equivalent inductance higher than the self-inductance of the respective coil wound on the respective leg, (e.g., 22% higher). A respective coil or phase winding can surround each leg, and a portion of two respective phase windings can be disposed in each respective window. The magnetic core can be laminated type construction formed with nanocrystalline material to provide an improved trade-off between saturation flux density (e.g., a maximum flux density the magnetic core material can maintain) and high frequency core loss (e.g., due to hysteresis and eddy currents) compared to conventional devices with other magnetic materials. Aspects can further include gaps defined between opposing cores on each leg to reduce core loss compared to conventional gapless magnetic cores. Aspects can also include two air gaps per leg, to enable each of the two gaps to be smaller than a single air gap per leg to reduce hysteresis loss and fringing flux loss by reducing each gap thickness. Non-limiting aspects can further include a thermally conductive ceramic shim disposed in the air gaps, and a thermally conductive baseplate with heat conducting fins to reduce heat in the magnetic core.

Reference will now be made in detail to present aspects of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

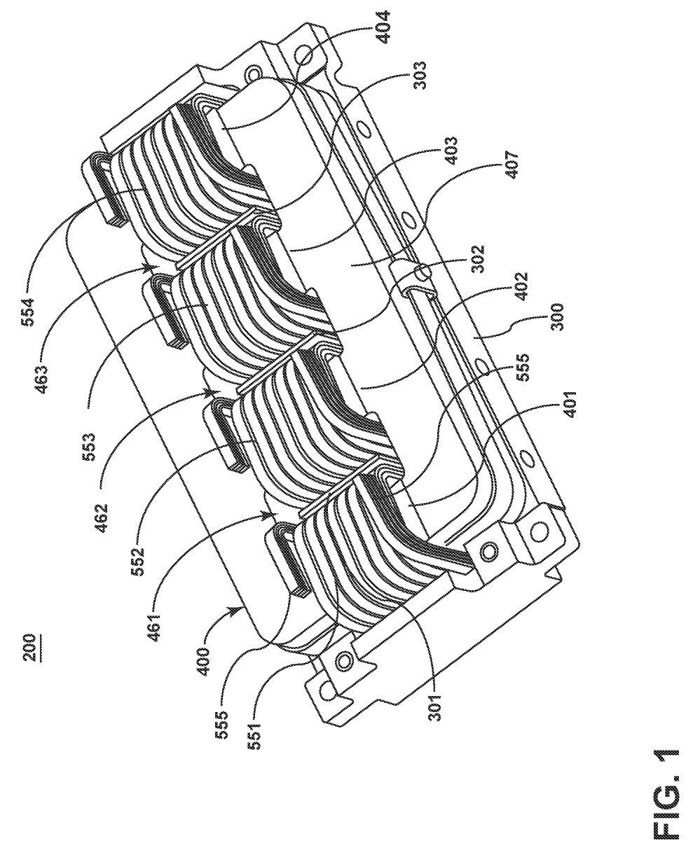

FIG. 1 depicts a coupled inductor 200 in accordance with a non-limiting aspect. The coupled inductor 200 can include a four-leg magnetic core 400 supported by or coupled to a baseplate 300. The baseplate 300 can include a shelf portion 310 having a set of inner fins 301, 302, 303 extending outwardly therefrom. The shelf portion 310 can further include a set of outer fins 304, 305 extending outwardly therefrom. The magnetic core 400 can include a set of core segments 407 arranged to define a set of core legs 401-404. For example, in non-limiting aspects, the magnetic core can include a first leg 401, a second leg 402, a third leg 403, and a fourth leg 404. The core segments 407 can be C-shaped. The core legs 401-404 can be spaced from each other to define a set of windows 461, 462, 463 therethrough. A respective coil or phase winding 551-554 can be wound or coiled around each core leg 401-404 of the magnetic core 400. Each phase winding 551-554 can include a respective set of winding ends 555 for electrical connection to circuit wiring (not shown). Although omitted for clarity of illustration, in non-limiting aspects, a respective termination or connector (e.g., a spade terminal, a crimp connector, a solder tab, etc.) can be electrically coupled to each winding end 555.

In non-limiting aspects, the set of windows 461-463 can include a first window 461, a second window 462, and a third window 463. The respective phase windings 551-554 can include a first phase winding 551, a second phase winding 552, a third phase winding 553, and a fourth phase winding 554. The first phase winding 551 can be coiled around the first leg 401, second phase winding 552 can be coiled around the second leg 402, the third phase winding 553 can be coiled around the third leg 403, and the fourth phase winding 554 can be coiled around the fourth leg 404. A portion of each phase winding 551-554 can extend through a respective window 461, 462, 463. As such, in non-limiting aspects, each window 461-463 can have a portion of two respective phase windings 551-554 extending therethrough. For example, in non-limiting aspects, a portion of the first phase winding 551 and a portion of the second phase winding 552 can extend through the first window 461, another portion of the second phase winding 552 and a portion of the third phase winding 553 can extend through the second window 462, and another portion of the third phase winding 553 and a portion of the fourth phase winding 554 can extend through the third window 463.

The set of inner fins 301-303 can include a first inner fin 301, a second inner fin 302, and a third inner fin 303. Each inner fin 301-303 can extend into a respective window 461-463. In non-limiting aspects, each inner fin 301-303 can be disposed to extend between two respective phase windings 551-554. For example, as illustrated, the first inner fin 301 can be arranged to extend through the first window 461 between the first phase winding 551 and the second phase winding 552, the second inner fin 302 can be arranged to extend through the second window 462 between the second phase winding 552 and the third phase winding 553, and the third inner fin 303 can be arranged to extend through the third window 463 between the third phase winding 553 and the fourth phase winding 554. As such, in non-limiting aspects, each window 461-463 can have a portion of a respective inner fin 301-303 extending therethrough.

The outer fins 304, 305 are disposed outside of the magnetic core 400 and do not extend into the window 461-463. For example, the set of outer fins 304, 305 can include a first outer fin 304 and a second outer fin 305. The first outer fin 304 and the second outer fin can be disposed at opposing ends of the baseplate 300. In non-limiting aspects, the first outer fin 304 can be disposed adjacent to the first phase winding 551 and the second outer fin 305 can be disposed adjacent to the third phase winding 553. In such aspects, each phase winding 551-553 can be disposed between two respective fins. For example, the first phase winding 551 can be disposed between the first outer fin 304 and the first inner fin 301, the second phase winding 552 can be disposed between the first inner fin 301 and the second inner fin 302, the third phase winding 553 can be disposed between the second inner fin 302 and the third inner fin 303, and the third phase winding 553 can be disposed between the third inner fin 303 and the second outer fin 305. As such, in non-limiting aspects, the outer fins 304, 305 do not extend into any of the windows 461-463.

In operation, the phase windings 551-554 are disposed around the core legs 401-404 respectively. When energized, the phase windings 551-554 induce magnetic flux (not shown) into the core legs 401-404 and core segments 407 of the magnetic core 400. Heat generated during operation of the phase windings 551-554 can be conducted away from the phase windings 551-554 by the inner fins 301-303 and the outer fins 304-305.

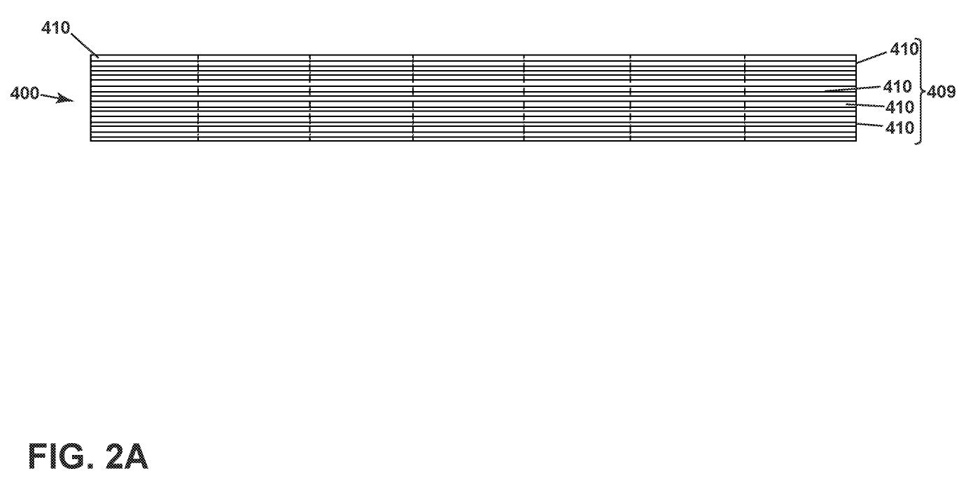

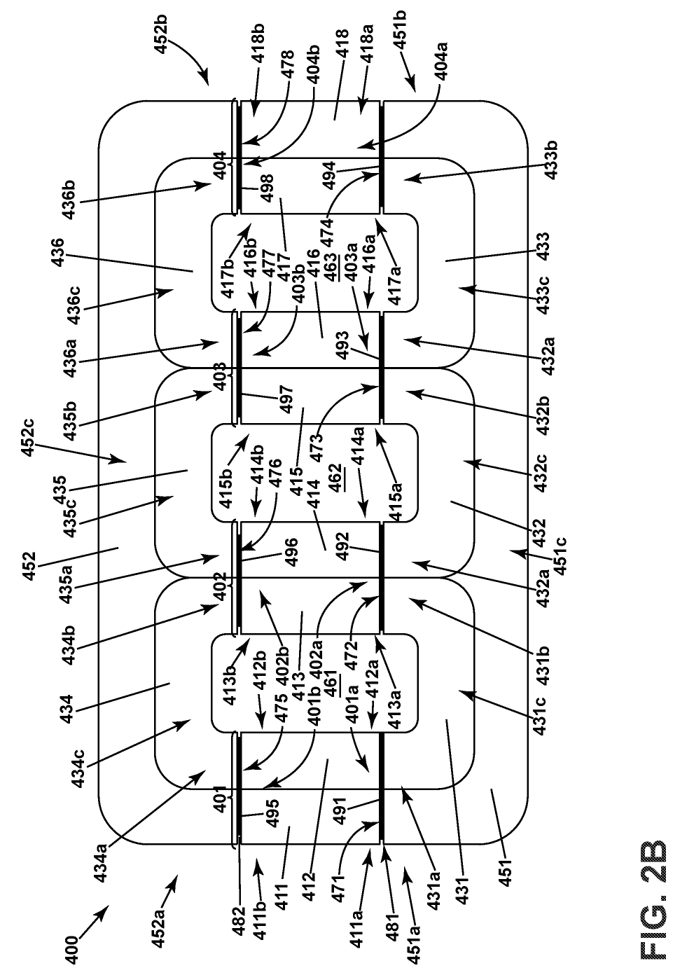

FIG. 2A is an isometric front view of the magnetic core 400 of FIG. 1. As illustrated, the magnetic core 400 can be defined by a set of laminations or magnetic layers 410 arranged to define a stacked-up structure 409.

In one non-limiting aspect, the magnetic layers 410 can be formed of ferrite. In some aspects, the magnetic layers 410 can include nanocrystalline alloys, such as for example, FINEMET ^{®}, Vitreperm^{®}, Nanoperm^{®}, and HiTPerm ^{®}. In other non-limiting aspects, the magnetic layers 410 can be formed e.g. of a transition metal, such as iron (Fe), cobalt (Co), or nickel (Ni). In other non-limiting aspects, the magnetic layers 410 can be formed of silicon steel, hiperco ^{®}, or dual-phase magnetic materials. In still other aspects, the magnetic layers 410 can include e.g. crystalline, nanocrystalline, amorphous soft or permanent magnetic alloy. In other aspects, the magnetic layers 410 can include silicon, iron-cobalt (e.g., hiperco^{®}, supermendur) or iron-nickel (permalloy). In still other aspects, the magnetic layers 410 can be formed e.g. an amorphous soft magnetic alloy, e.g. an Fe-based alloys, Co-based alloy, an Fe—Ni based alloy including Metglas^{®} and Vitrovac ^{®}. The magnetic layers 410 can also include alternative permanent magnetic material, such as Neodymium-Iron-Boron, Samarium Cobalt, hexaferrite, Alnico, or Cunife.

FIG. 2B is an isometric top view of the magnetic core 400 of FIG. 2A. The set of core segments 407 can include a first set of inner core segments 431-433, a second set of inner core segments 434-436, and a set of outer core segments 451, 452. In non-limiting aspects, the first set of inner core segments 431-433, the second set of inner core segments 434-436, and the set of outer core segments 451, 452 can be C-shaped segments. The core legs 401-404, the first set of inner core segments 431-433, and the second set of inner core segments 434-436, can be cooperatively arranged to define a set of windows 461-463 extending through the magnetic core 400. The magnetic core 400 can further define a first set of air gaps 471-473, or a second set of air gaps 474-478 or both.

The set of core legs 401-404 can include the first leg 401, the second leg 402, the third leg 403, and the fourth leg 404. The core legs 401-404 are spaced apart from each other. For example, in non-limiting aspects, the core legs 401-404 can be arranged in parallel with each other, with the first leg 401 and the fourth leg 404 arranged as outer core legs, and the second leg 402 and the third leg 403 disposed therebetween as intermediate core legs. Each core leg 401-404 includes a respective first end 401a-404a, a respective opposing second end 401b-404b, and a respective intermediate portion 401c-404c extending therebetween. In non-limiting aspects, the core legs 401-404 can extend between a respective first air gap 471-473 and a respective second air gap 474-478.

In non-limiting aspects, each core leg 401-404 can include respective adjacent abutting pairs of leg segments 411-418. For example, in non-limiting aspects, the first leg 401 can be defined by a first pair of leg segments including a first leg segment 411, and a second leg segment 412, the second leg 402 can be defined by a second pair of leg segments including a third leg segment 413, and a fourth leg segment 414, the third leg 403 can be defined by the third pair of leg segments including a fifth leg segment 415, and a sixth leg segment 416, and the fourth leg 404 can be defined by a fourth pair of leg segments including a seventh leg segment 417, and an eighth leg segment 418. Each leg segment 411-418 can extend from a respective leg segment first end 411a- 418a to an opposing leg segment second end 411b-418b with a respective leg segment intermediate portion 411c-418c extending between the respective leg segment first end 411a-418a and respective leg segment second end 411b-418b. In non-limiting aspects, each respective intermediate portion 411c-418c of the set of core legs 401-404 can abut another respective leg segment 411c-418c to define an adjacent abutting pair of leg segments 411-418. In non-limiting aspects, the abutting pairs of leg segments 411-418 can extend between a respective first air gap 471-473 and a respective second air gap 474-478.

The first set of inner core segments 431-433 can include a first inner core segment 431, a second inner core segment 432, and a third inner core segment 433. The second set of inner core segments 434-436 can include a fourth inner core segment 434, a fifth inner core segment 435, and a sixth inner core segment 436. Each of the first set of inner core segments 431-433 and the second set of inner core segments 434-436, can be C-shaped. For example, the first set of inner core segments 431-433 can extend from a respective inner core segment first end 431a-433a to a respective inner core segment second end 431b-433b with a respective inner core segment intermediate portion 431c-433c extending between the respective inner core segment first end 431a-433a and respective inner core segment second end 431b-433b. Likewise, the second set of inner core segments 434-436 can extend from a respective inner core segment first end 434a-436a to a respective inner core segment second end 434b-436b with a respective inner core segment intermediate portion 434c-436c extending between the respective inner core segment first end 434a-436a and respective inner core segment second end 434b-436b. Each respective inner core segment 431-436 can be magnetically coupled to and extend between two adjacent core legs 401-404. In non-limiting aspects, each inner core segment first end 431a-436a can be magnetically coupled with a respective leg segment 411-418, and each inner core segment second end 431b-436b can be magnetically coupled with another respective leg segment 411-418.

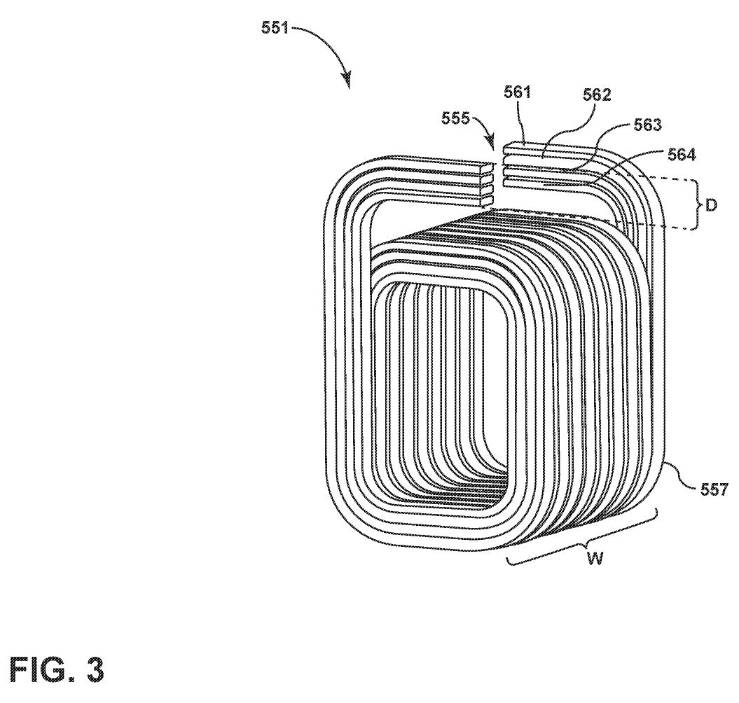

For example, in non-limiting aspects, the first inner core segment 431 can extend from a first end 412a of the second leg segment 412 to a first end 413a of the third leg segment 413; the second inner core segment 432 can extend from a first end 414a of the fourth leg segment 414 to a first end 415a of the fifth leg segment 415; the third inner core segment 433 can extend from a first end 416a of the sixth leg segment 416 to a first end 417a of the seventh leg segment 417; the fourth inner core segment 434 can extend from a second end 412b of the second leg segment 412 to a second end 413b of the third leg segment 413; the fifth inner core segment 435 can extend from a second end 414b of the fourth leg segment 414 to a second end 415b of the fifth leg segment 415; the sixth inner core segment 436 can extend from a second end 416b of the sixth leg segment 416 to a second end 417b of the seventh leg segment 417. Each inner core segment of the first set of inner core segments 431-433 can be arranged to oppose a corresponding other inner core segment of the second set of inner core segments 434-436. For example, as illustrated in the non-limiting aspect of FIG. 3B, the first inner core segment 431 can be opposingly spaced from the fourth inner core segment 434, the second inner core segment 432 can be opposingly spaced from the fifth inner core segment 435, and the third inner core segment 433 can be opposingly spaced from the sixth inner core segment 436.

The set of outer core segments 451, 452 can include a first outer core segment 451 and a second outer core segment 452. The outer core segments 451, 452 can be C-shaped. In non-limiting aspects, the outer core segments 451, 452 can extend from a respective outer core segment first end 451a, 452a to a respective outer core segment second end 451b, 452b with a respective outer core segment intermediate portion 451c, 452c extending between the respective outer core segment first end 451a, 452a and respective outer core segment second end 451b, 452b. The first outer core segment 451 and the second outer core segment 452 can be magnetically coupled to and extend between the first leg 401 and the fourth leg 404 (e.g., the two outer core legs 401, 404).

For example, in non-limiting aspects, the first outer core segment 451 can extend from the first end 411a of the first leg segment 411 to the first end 418a of the eighth leg segment 418, and the second outer core segment 452 can extend from the second end 411b of the first leg segment 411 to the second end 418b of the eighth leg segment 418. In this way, the set of outer core segments 451, 452, the first leg segment 411, and the eighth leg segment 418 (e.g., the first core leg and fourth leg 404) can define a periphery of the magnetic core 400. In non-limiting aspects, the intermediate portion 451c of the first outer core segment 451 can extend parallel to the intermediate portions 431c, 432c, 433c of the first inner core segment 431, the second inner core segment 432, and the third inner core segment 433, respectively. In non-limiting aspects, the intermediate portion 451c of the first outer core segment 451 can abut the intermediate portions 431c, 432c, 433c of the first inner core segment 431, the second inner core segment 432, and the third inner core segment 433, respectively. In non-limiting aspects, the intermediate portion 452c of the second outer core segment 452 can extend parallel to the intermediate portions 434c, 435c, 436c of the fourth inner core segment 434, the fifth inner core segment 435, and the sixth inner core segment 436, respectively. In non-limiting aspects, the intermediate portion 452c of the second outer core segment 452 can abut to the intermediate portions 434c, 435c, 436c of the fourth inner core segment 434, the fifth inner core segment 435, and the sixth inner core segment 436, respectively.

As illustrated in FIG. 2B, the set of windows 461-463 can include a first window 461, a second window 462, and a third window 463. In non-limiting aspects, each window 461-463 can be defined by a respective opposing pair of core legs 401-404, and a pair of opposing inner core segments 431-436. For example, the first window 461 can be defined between the first leg 401 and the second leg 402 (e.g., between the second leg segment 412 and the third leg segment 413), and between the first inner core segment 431 and the fourth inner core segment 434. The second window 462 can be defined between the second leg 402 and the third leg 403 (e.g., between the fourth leg segment 414 and the fifth leg segment 415), and between the second inner core segment 432 and the fifth inner core segment 435. The third window 463 can be defined between the third leg 403 and the fourth leg 404 (e.g., between the sixth leg segment 416 and the seventh leg segment 417), and between the third inner core segment 433 and the sixth inner core segment 436.

The first set of air gaps 471-474 can include a first air gap 471, a second air gap 472, a third air gap 473, and a fourth air gap 474. In non-limiting aspects, the first set of air gaps 471-474 be defined between the respective first end 401a-404a of the core legs 401-404 and corresponding inner core segments of the first set of inner core segments 431-433, and the first outer core segment 451.

The second set of air gaps 475-478 can include a fifth air gap 475, a sixth air gap 476, a seventh air gap 477, and an eighth air gap 478. In non-limiting aspects, the second set of air gaps 475-478 can be defined between respective the respective second end 401b-404b of the core legs 401-404 and corresponding inner core segments of the second set of inner core segments 434-438, the second outer core segment 452.

For example, in non-limiting aspects, the first air gap 471 can be defined between the first end 451a of the first outer core segment 451 and the first end 411a of the first leg segment 411, and between the first end 431a of the first inner core segment 431 and the first end 412a of the second leg segment 412. The second air gap 472 can be defined between the second end 431b of the first inner core segment 431 and the first end 413a of the third leg segment 413, and between the first end 432a of the second inner core segment 432 and the first end 414a of the fourth leg segment 414. The third air gap 473 can be defined between the second end 432b of the second inner core segment 432 and the first end 415a of the fifth leg segment 415, and between the first end 433a of the third inner core segment 433 and the first end 416a of the sixth leg segment 416. The fourth air gap 474 can be defined between the second end 433b of the third inner core segment 433 and the first end 417a of the seventh leg segment 417, and between the second end 451b of the first outer core segment 451 and the first end 418a of the eighth leg segment 418. The fifth air gap 475 can be defined between the first end 452a of the second outer core segment 452 and the second end 411b of the first leg segment 411, and between the first end 434a of the fourth inner core segment 434 and the second end 412b of the second leg segment 412. The sixth air gap 476 can be defined between the second end 434b of the fourth inner core segment 434 and the second end 413b of the third leg segment 413, and between the first end 435a of the fifth inner core segment 435 and the second end 414b of the fourth leg segment 414. The seventh air gap 477 can be defined between the second end 435b of the fifth inner core segment 435 and the second end 415b of the fifth leg segment 415, and between the first end 436a of the sixth inner core segment 436 and the second end 416b of the sixth leg segment 416. The eighth air gap 478 can be defined between the second end 452b of the second outer core segment 452 and the second end 418b of the eighth leg segment 418, and between the second end 436b of the sixth inner core segment 436 and the second end 417b of the seventh leg segment 417.

In non-limiting aspects, the first air gap 471, the second air gap 472, the third air gap 473, and the fourth air gap 474, can be fluidly coupled with the first window, 461, the second window 462 and the third window 463 to define a continuous first aperture 481 through the magnetic core 400. Similarly, in non-limiting aspects, the fifth air gap 475, and sixth air gap 476, the seventh air gap 477, and the eighth air gap 478 can be fluidly coupled with the first window, 461, the second window 462 and the third window 463 to define a continuous second aperture 482 extending through the magnetic core 400.

In non-limiting aspects, a first set of shims 491-494 can be respectively disposed in the first set of air gaps 471-474. Additionally, in non-limiting aspects a second set of shims 495-498 can be respectively disposed in the second set of air gaps 475-478. For example, the first set of shims 491-494 can include a first shim 491 disposed in the first air gap 471, a second shim 492 disposed in the second air gap 472, a third shim 493 disposed in the third air gap 473, and a fourth shim 494 disposed in the fourth air gap 474. In non-limiting aspects, the second set of shims 495-498 can include a fifth shim 495 disposed in the fifth air gap 475, a sixth shim 496 disposed in the sixth air gap 476, a seventh shim 497 disposed in the seventh air gap 477, and an eighth shim 498 disposed in the eighth air gap 478.

The first set of shims 491-494 or the second set of shims 495-498, or both, can be arranged to prevent a relative movement between corresponding core segments and core legs. For example, in non-limiting aspects, the first set of shims 491-494 can be coupled to a respective first end 401a-404a of the core legs 401-404 and further coupled to a corresponding inner core segment of the first set of inner core segments 431-433, and the first outer core segment 451. In non-limiting aspects, a second set of shims 495-498 can be coupled to a respective second end 401b-404b of the core legs 401-404 and coupled to a corresponding inner core segment of the second set of inner core segments 434-438, and the second outer core segment 452. In some aspects, the first set of shims 491-494 or the second set of shims 495-498, or both, can be retained in place by a friction fit. In other aspects, the first set of shims 491-494 or the second set of shims 495-498, or both, can be retained in place by a interference fit.

In non-limiting aspects, the first set of shims 491-494 or the second set of shims 495-498, or both, can be thermally conductive. In non-limiting aspects, the first set of shims 491-494 or the second set of shims 495-498, or both can be formed from a ceramic material. For example, in non-limiting aspects, the ceramic material can include, without limitation aluminum oxide (Al2O3), silicon carbide (SiC), silicon dioxide (SiO2), magnesium oxide (MgO), zirconium dioxide (ZrO2), yttria stabilized zirconia (YSZ), Silicon Nitride (Si3N4), aluminum nitride (AlN), boron carbide (B4C), and boron nitride (BN), individually, or in various combinations thereof. Additionally, the ceramic material can comprise any of glass and glass ceramics, such as Borosilicate glass, quartz, alumino-silicates, silicate ceramics, or magnesium silicates individually, or in various combinations thereof. The first set of shims 491-494 or the second set of shims 495-498, or both, can operatively conduct or transfer heat from the magnetic core 400.

FIG. 3 depicts a non-limiting aspect of a winding, such as the first phase winding 551, with the respective terminations omitted from each respective winding end 555 for clarity. The first phase winding 551 can be formed as a coil having any number of wraps or turns 557 (e.g., nine turns of an insulated rectangular magnetic wire having 0.051 inches high by 0.144 inches wide) or wraps to define a coil width “W”. As illustrated, the first phase winding 551 can be coiled as a set of winding layers 561, 562, 563, 564. For example, each turn 557 can be arranged as a set of four concentric layers, 561, 562, 563, 564. When so arranged, the turns 557 can define a winding depth “D”. For example, in the illustrated aspect, the turns 557 of the first phase winding 551 include four layers, namely a first winding layer 561, a second winding layer 562, a third winding layer 563, and a fourth winding layer 564. Other aspects are not so limited, and it is contemplated that the first phase winding 551 can include any predetermined number of turns 557, to define or predetermined coil width W, wherein each turn comprises multiple concentric winding layers 561, 562, 563, 564 to define any predetermined depth D.

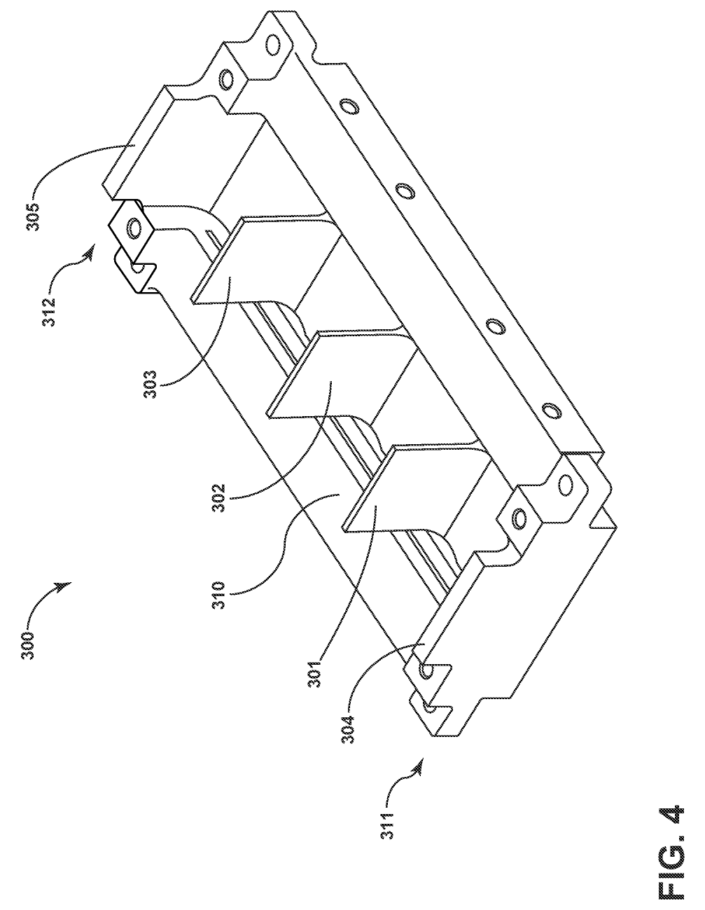

FIG. 4 depicts a non-limiting aspect of the baseplate 300. The baseplate 300 can be formed of a thermally conductive material such as aluminum. The shelf portion 310 can define a top surface of the baseplate 300 and can be configured to supportably receive the magnetic core 400 thereon. The shelf portion 310 can extend from a first end 311 to an opposing second end 312.

The set of inner fins 301-303 are spaced apart from each other and extend outwardly in a common direction from the shelf portion 310. The inner fins 301-303 are arranged to operatively extend into a respective window 461- 463 of the magnetic core 400 (FIG. 1) when the magnetic core 400 is disposed on the shelf portion 310. The shelf portion 310 can further include a set of outer fins 304, 305 extending outwardly therefrom. The outer fins 304-305 are configured to be outside of the magnetic core 400 and do not extend into the window 461-463 (FIG. 1). The outer fins 304, 305 can be disposed on opposing ends of the shelf portion 310. For example, the first outer fin 304 can be disposed on the first end 311 of the shelf portion 310, and the second outer fin 305 can be disposed on the second end 312 of the shelf portion 310.

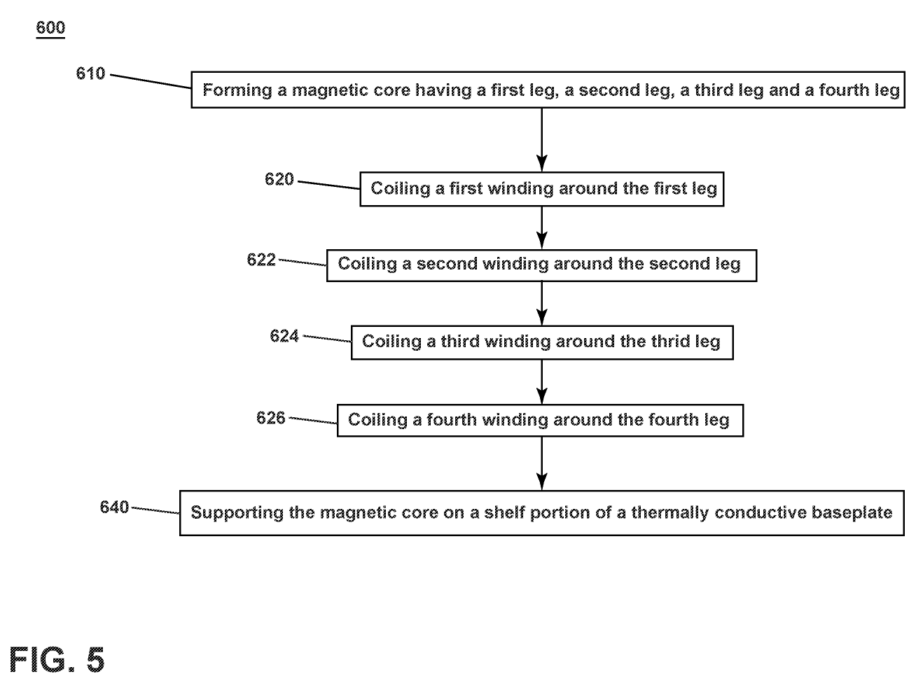

FIG. 5 depicts a method 600 of fabricating a four-leg coupled inductor 200. Although described in terms of a coupled inductor, it will be appreciated that the method 600 can be applied to any inductive electrical device, such as a transformer, without departing from the disclosure herein. While the method 600 will be described herein, for ease of understanding, in terms of the coupled inductor 200 of FIGS. 1-4, other aspects are not so limited and the method 600 can be implemented in any environment using other elements without departing from the scope of the disclosure.

The method 600 can begin at 610 by forming a magnetic core 400. The magnetic core 400 can be defined by a set of laminations or magnetic layers 410 arranged to define a stacked-up structure 409.

In one non-limiting aspect, the magnetic layers 410 can be formed of ferrite. In some aspects, the magnetic layers 410 can include nano-crystalline material or alloys, such as for example, FINEMET^{®}, Vitreperm^{®}, Nanoperm^{®}, and HiTPerm^{®}. In other non-limiting aspects, the magnetic layers 410 can be formed e.g. of a transition metal, such as iron (Fe), cobalt (Co), or nickel (Ni). In other non-limiting aspects, the magnetic layers 410 can be formed of silicon steel, hiperco^{®}, or dual-phase magnetic materials. In still other aspects, the magnetic layers 410 can include e.g. crystalline, nanocrystalline, amorphous soft or permanent magnetic alloy. In other aspects, the magnetic layers 410 can include silicon, iron-cobalt (e.g., hiperco^{®}, supermendur) or iron-nickel (permalloy). In still other aspects, the magnetic layers 410 can be formed e.g. an amorphous soft magnetic alloy, e.g. an Fe-based alloys, Co-based alloy, an Fe—Ni based alloy including Metglas^{®} and Vitrovac^{®}. The magnetic layers 410 can also include alternative permanent magnetic material, such as Neodymium-Iron-Boron, Samarium Cobalt, hexaferrite, Alnico, or Cunife.

The magnetic core 400 can include a first leg 401, a second leg 402, a third leg 403, and a fourth leg 404, spaced from each other. The magnetic core 400 can further include a set of inner core segments 431-436. The inner core segments 431-436 can be C-shaped. The inner core segments 431-436 can include a first inner core segment 431 extending between magnetically coupled to a first end 401a of the first leg 401 and a first end 402a of the second leg 402; a second inner core segment 432 extending between and magnetically coupled to the first end 402a of the second leg 402 and a first end 403a of the third leg 403; a third inner core segment 433 extending between and magnetically coupled to the first end 403a of the third leg 403 and a first end 404a of the fourth leg 404; a fourth inner core segment 434 extending between and magnetically coupled to a second end 401b of the first leg 401 and a second end 402b of the second leg 402; a fifth inner core segment 435 extending between and magnetically coupled to a second end 402b of the second leg 402 and a second end 403b of the third leg 403; a sixth inner core segment 436 extending between and magnetically coupled to the second end 403b of the third leg 403 and a second end 404b of the fourth leg 404. The magnetic core 400 can further include a set of C-shaped outer core segments 451-452. The outer core segments 451-452 can include a first outer core segment 451 extending between and magnetically coupled to the first end 401a of the first leg 401 and the first end 404a of the fourth leg 404; and a second outer core segment 452 extending between and magnetically coupled to the second end 401b of the first leg 401 and the second end 404b of the fourth leg. 404. The magnetic core 400 can also include a first window 461 defined between the first leg 401 and the second leg 402, a second window 462 defined between the second leg 402 and the third leg 403, and a third window 463 defined between the third leg 403 and the fourth leg 404.

In non-limiting aspects, the forming the magnetic core 400 at 610 can further include defining a first set of air gaps 471-473 defined between the respective first ends 401a-404a of the core legs 401-404 and at least one of the first set of inner core segments 431-433 and the first outer core segment 451, and a second set of air gaps 474-476 defined between the respective second ends 401b-404b of the core legs 401-404 and at least one of the second set of inner core segments 434-436 and the second outer core segment 452.

In non-limiting aspects, the first set of air gaps 471-473 and the first window 461, the second window 462, and the third window 463 cooperatively define a continuous first aperture 481 through the magnetic core 400, and wherein the second set of air gaps 474-476 and the first window 461 the second window 462, and the third window 463 cooperatively define a continuous second aperture 482 through the magnetic core 400.

The method 600 can include, at 620, coiling a first phase winding 551 around the first leg 401, a portion of the first phase winding 551 extending through the first window 461. The method 600 can include at 622, coiling a second phase winding 552 around the second leg 402, having a portion extending through the first window 461, and another portion extending through the second window 462. The method 600 can include at 624, coiling a third phase winding 553 around the third leg 403, having a portion extending through the second window 462, and another portion extending through the third window 463. The method 600 can include, at 626, coiling a fourth phase winding 554 around the fourth leg 404, having a portion extending through the third window 463.

The method 600 can include, at 640, supporting the magnetic core on a shelf portion 310 of a thermally conductive baseplate 300. In non-limiting aspects, the baseplate 300 can further include a first inner fin 301 extending from the shelf portion 310, a second inner fin 302 extending from the shelf portion 310, and a third inner fin 303 extending from the shelf portion 310. In such aspects, the supporting the magnetic core on a shelf portion 310 can include disposing the first inner fin 301 through the first window 461, disposing the second inner fin 302 through the second window 462, and disposing the third inner fin 303 through the third window 463. In non-limiting aspects, baseplate can further include a first outer fin 304, and a second outer fin 305, extending from opposing ends of the shelf portion 310. In such aspects, the supporting the magnetic core 400 on the shelf portion 310 can further include disposing the first outer fin 304 outside of the first window 461 and disposing the second outer fin 305 outside of the third window 463.

The sequence depicted is for illustrative purposes only and are not meant to limit the aspects of the disclosure in any way, as it is understood that the portions of the disclosure of application thereof can proceed in a different logical order, additional or intervening portions can be included, or described portions of the method can be divided into multiple portions, or described portions of the method can be omitted without detracting from the described method.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. Further aspects of the present disclosure are provided by the subject matter of the following clauses:

A four-leg coupled inductor comprising: a magnetic core having a first leg, a second leg, a third leg, and a fourth leg, spaced from each other; a first set of inner core segments, including: a first inner core segment extending between and magnetically coupled to a first end of the first leg and a first end of the second leg; a second inner core segment extending between and magnetically coupled to a first end of the second leg and a first end of the third leg, a third inner core segment extending between and magnetically coupled to a first end of the third leg and a first end of the fourth leg; a second set of inner core segments, including: a fourth inner core segment extending between and magnetically coupled to a second end of the first leg and a second end of the second leg; a fifth inner core segment extending between and magnetically coupled to a second end of the second leg and a second end of the third leg; a sixth inner core segment extending between and magnetically coupled to a second end of the third leg and a second end of the fourth leg; a set of outer core segments, including: a first outer core segment extending between and magnetically coupled to the first end of the first leg and the first end of the fourth leg; a second outer core segment extending between and magnetically coupled to the second end of the first leg and the second end of the fourth leg; a first window defined between the first leg and the second leg; a second window defined between the second leg and the third leg; a third window defined between the third leg and the fourth leg; a first phase winding coiled around the first leg, the first phase winding having a portion extending through the first window; a second phase winding coiled around the second leg, the second phase winding having a portion extending through the first window, and another portion extending through the second window; a third phase winding coiled around the third leg, the third phase winding having a portion extending through the second window, and another portion extending through the third window; and a fourth phase winding coiled around the fourth leg, the fourth phase winding having a portion extending through the third window.

The four-leg coupled inductor of any preceding clause, wherein the magnetic core is formed of a stack of magnetic layers.

The four-leg coupled inductor of any preceding clause, wherein the magnetic layers are formed of a nano-crystalline material.

The four-leg coupled inductor of any preceding clause, further including a set of air gaps defined between the respective first ends of the first, second, third, and fourth core legs and at least one of the first set of inner core segments and the first outer core segment.

The four-leg coupled inductor of any preceding clause, wherein the set of air gaps is a first set of air gaps, and further including a second set of air gaps defined between the respective second ends of the first, second, third, and fourth core legs and at least one of the second set of inner core segments and the second outer core segment.

The four-leg coupled inductor of any preceding clause, wherein the set of air gaps and the first window, the second window, and the third window cooperatively define a continuous aperture through the magnetic core.

The four-leg coupled inductor of any preceding clause, wherein the continuous aperture is a first aperture, and wherein the second set of air gaps and the first window, the second window, and the third window cooperatively define a continuous second aperture through the magnetic core.

The four-leg coupled inductor of any preceding clause, further comprising a respective shim disposed in at least one of the first set of air gaps or the second set of air gaps.

The four-leg coupled inductor of any preceding clause, wherein the respective shim is formed from a thermally conductive ceramic material.

The four-leg coupled inductor of any preceding clause, further including a baseplate having a shelf portion, wherein the magnetic core is supported by the shelf portion.

The four-leg coupled inductor of any preceding clause, wherein the baseplate further includes a first inner fin extending from the shelf portion and through the first window, a second inner fin extending from the shelf portion and through the second window, and a third inner fin extending from the shelf portion and through the third window.

The four-leg coupled inductor of any preceding clause, wherein the wherein the baseplate further includes a pair of outer fins disposed on opposing ends of the shelf portion and extending therefrom.

The four-leg coupled inductor of any preceding clause, wherein the first phase winding is disposed between a first outer fin and the first inner fin, the second phase winding is disposed between the first inner fin and the second inner fin, the third phase winding is disposed between the second inner fin and the third inner fin, and the fourth phase winding is disposed between the third inner fin and a second outer fin.

A method of forming a four-leg coupled inductor, comprising: forming a magnetic core having: a first leg, a second leg, a third leg, and a fourth leg, spaced from each other;
a set of inner core segments, including: a first inner core segment extending between magnetically coupled to a first end of the first leg and a first end of the second leg; a second inner core segment extending between and magnetically coupled to a first end of the second leg and a first end of the third leg; a third inner core segment extending between and magnetically coupled to a first end of the third leg and a first end of the fourth leg; a fourth inner core segment extending between and magnetically coupled to a second end of the first leg and a second end of the second leg; a fifth inner core segment extending between and magnetically coupled to a second end of the second leg and a second end of the third leg; a sixth inner core segment extending between and magnetically coupled to a second end of the third leg and a second end of the fourth leg; a set of outer core segments, including: a first outer core segment extending between and magnetically coupled to the first end of the first leg and the first end of the fourth leg; a second outer core segment extending between and magnetically coupled to the second end of the first leg and the second end of the fourth leg; a first window defined between the first leg and the second leg; a second window defined between the second leg and the third leg; a third window defined between the third leg and the fourth leg; coiling a first phase winding around the first leg, a portion of the first phase winding extending through the first window; coiling a second phase winding around the second leg, the second phase winding having a portion extending through the first window, and another portion extending through the second window; coiling a third winding around the third leg, the third phase winding having a portion extending through the second window, and another portion extending through the third window; and coiling a fourth winding around the fourth leg, the third phase winding having a portion extending through the third window.

The method of any preceding clause, wherein the magnetic core is formed of a stack of magnetic layers, wherein the magnetic layers are formed of a nano-crystalline material.

The method of any preceding clause, further wherein the forming the magnetic core further includes defining a first set of air gaps between the respective first ends of the first leg, the second leg, the third leg, and the fourth leg and at least one of the first set of inner core segments and the first outer core segment, and a second set of air gaps between the respective second ends of the first leg, the second leg, the third leg, and the fourth leg and at least one of the second set of inner core segments and the second outer core segment.

The method of any preceding clause, wherein the first set of air gaps and the first window, the second window, and the third window cooperatively define a continuous first aperture through the magnetic core, and wherein the second set of air gaps and the first window, the second window, and the third window cooperatively define a continuous second aperture through the magnetic core.

The method of any preceding clause, further comprising disposing a respective thermally conductive shim in at least one of the first set of air gaps or the second set of air gaps.

The method of any preceding clause, further comprising supporting the magnetic core on a baseplate having a shelf portion, wherein the baseplate includes a first inner fin, a second inner fin, and a third inner fin extending from the shelf portion, and wherein the supporting the magnetic core on the baseplate includes disposing the first inner fin through the first window, disposing the second inner fin through the second window, and disposing the third inner fin through the third window.

The method of any preceding clause, wherein the baseplate further includes a first outer fin and a second outer fin extending from opposing ends of the shelf portion, and wherein supporting the magnetic core on the baseplate further includes disposing the first outer fin outside of the first window and disposing the second outer fin outside of the third window.

1. A four-leg coupled inductor comprising:
a magnetic core having
a first leg, a second leg, a third leg, and a fourth leg, spaced from each other;
a first set of inner core segments, including:
a first inner core segment extending between and magnetically coupled to a first end of the first leg and a first end of the second leg;
a second inner core segment extending between and magnetically coupled to a first end of the second leg and a first end of the third leg
a third inner core segment extending between and magnetically coupled to a first end of the third leg and a first end of the fourth leg;
a second set of inner core segments, including:
a fourth inner core segment extending between and magnetically coupled to a second end of the first leg and a second end of the second leg;
a fifth inner core segment extending between and magnetically coupled to a second end of the second leg and a second end of the third leg;
a sixth inner core segment extending between and magnetically coupled to a second end of the third leg and a second end of the fourth leg;
a set of outer core segments, including:
a first outer core segment extending between and magnetically coupled to the first end of the first leg and the first end of the fourth leg;
a second outer core segment extending between and magnetically coupled to the second end of the first leg and the second end of the fourth leg;
a first window defined between the first leg and the second leg;
a second window defined between the second leg and the third leg;
a third window defined between the third leg and the fourth leg;
a first phase winding coiled around the first leg, the first phase winding having a portion extending through the first window;
a second phase winding coiled around the second leg, the second phase winding having a portion extending through the first window, and another portion extending through the second window;
a third phase winding coiled around the third leg, the third phase winding having a portion extending through the second window, and another portion extending through the third window; and
a fourth phase winding coiled around the fourth leg, the fourth phase winding having a portion extending through the third window.

2. The four-leg coupled inductor of claim 1, wherein the magnetic core is formed of a stack of magnetic layers.

3. The four-leg coupled inductor of claim 2, wherein the magnetic layers are formed of a nano-crystalline material.

4. The four-leg coupled inductor of claim 1, further including a set of air gaps defined between the respective first ends of the first, second, third, and fourth core legs and at least one of the first set of inner core segments and the first outer core segment.

5. The four-leg coupled inductor of claim 4, wherein the set of air gaps is a first set of air gaps, and further including a second set of air gaps defined between the respective second ends of the first, second, third, and fourth core legs and at least one of the second set of inner core segments and the second outer core segment.

6. The four-leg coupled inductor of claim 4, wherein the set of air gaps and the first window, the second window, and the third window cooperatively define a continuous aperture through the magnetic core.

7. The four-leg coupled inductor of claim 6, wherein the continuous aperture is a first aperture, and wherein the second set of air gaps and the first window, the second window, and the third window cooperatively define a continuous second aperture through the magnetic core.

8. The four-leg coupled inductor of claim 5, further comprising a respective shim disposed in at least one of the first set of air gaps or the second set of air gaps.

9. The four-leg coupled inductor of claim 8, wherein the respective shim is formed from a thermally conductive ceramic material.

10. The four-leg coupled inductor of claim 1, further including a baseplate having a shelf portion, wherein the magnetic core is supported by the shelf portion.

11. The four-leg coupled inductor of claim 10, wherein the baseplate further includes a first inner fin extending from the shelf portion and through the first window, a second inner fin extending from the shelf portion and through the second window, and a third inner fin extending from the shelf portion and through the third window.

12. The four-leg coupled inductor of claim 11, wherein the baseplate further includes a pair of outer fins disposed on opposing ends of the shelf portion and extending therefrom.

13. The four-leg coupled inductor of claim 12, wherein the first phase winding is disposed between a first outer fin and the first inner fin, the second phase winding is disposed between the first inner fin and the second inner fin, the third phase winding is disposed between the second inner fin and the third inner fin, and the fourth phase winding is disposed between the third inner fin and a second outer fin.

14. A method of forming a four-leg coupled inductor, comprising:
forming a magnetic core having:
a first leg, a second leg, a third leg, and a fourth leg, spaced from each other;
a set of inner core segments, including:
a first inner core segment extending between magnetically coupled to a first end of the first leg and a first end of the second leg;
a second inner core segment extending between and magnetically coupled to a first end of the second leg and a first end of the third leg;
a third inner core segment extending between and magnetically coupled to a first end of the third leg and a first end of the fourth leg;
a fourth inner core segment extending between and magnetically coupled to a second end of the first leg and a second end of the second leg;
a fifth inner core segment extending between and magnetically coupled to a second end of the second leg and a second end of the third leg;
a sixth inner core segment extending between and magnetically coupled to a second end of the third leg and a second end of the fourth leg;
a set of outer core segments, including:
a first outer core segment extending between and magnetically coupled to the first end of the first leg and the first end of the fourth leg;
a second outer core segment extending between and magnetically coupled to the second end of the first leg and the second end of the fourth leg;
a first window defined between the first leg and the second leg;
a second window defined between the second leg and the third leg;
a third window defined between the third leg and the fourth leg;
coiling a first phase winding around the first leg, a portion of the first phase winding extending through the first window;
coiling a second phase winding around the second leg, the second phase winding having a portion extending through the first window, and another portion extending through the second window;
coiling a third phase winding around the third leg, the third phase winding having a portion extending through the second window, and another portion extending through the third window; and
coiling a fourth winding around the fourth leg, the third phase winding having a portion extending through the third window.

15. The method of claim 14, wherein the magnetic core is formed of a stack of magnetic layers, wherein the magnetic layers are formed of a nano-crystalline material.

16. The method of claim 14, further wherein the forming the magnetic core further includes defining a first set of air gaps between the respective first ends of the first leg, the second leg, the third leg, and the fourth leg and at least one of the first set of inner core segments and the first outer core segment, and a second set of air gaps between the respective second ends of the first leg, the second leg, the third leg, and the fourth leg and at least one of the second set of inner core segments and the second outer core segment.

17. The method of claim 16, wherein the first set of air gaps and the first window, the second window, and the third window cooperatively define a continuous first aperture through the magnetic core, and wherein the second set of air gaps and the first window, the second window, and the third window cooperatively define a continuous second aperture through the magnetic core.

18. The method of claim 16, further comprising disposing a respective thermally conductive shim in at least one of the first set of air gaps or the second set of air gaps.

19. The method of claim 14, further comprising supporting the magnetic core on a baseplate having a shelf portion, wherein the baseplate includes a first inner fin, a second inner fin, and a third inner fin extending from the shelf portion, and wherein the supporting the magnetic core on the baseplate includes disposing the first inner fin through the first window, disposing the second inner fin through the second window, and disposing the third inner fin through the third window.

20. The method of claim 19, wherein the baseplate further includes a first outer fin and a second outer fin extending from opposing ends of the shelf portion, and wherein supporting the magnetic core on the baseplate further includes disposing the first outer fin outside of the first window and disposing the second outer fin outside of the third window.
